(19) United States
(12) Patent Application Publication
(10) Pub. No.: US 2020/0199716 A1
(43) Pub. Date: Jun. 25, 2020

(54) ADDITIVELY MANUFACTURED HIGH-TEMPERATURE ALUMINUM ALLOYS, AND FEEDSTOCKS FOR MAKING THE SAME

(71) Applicant: HRL Laboratories, LLC, Malibu, CA (US)

(72) Inventors: Tobias A. SCHAEDLER, Oak Park, CA (US); Jacob M. HUNDLEY, Thousand Oaks, CA (US); John H. MARTIN, Oxnard, CA (US); Julie A. MILLER, Los Angeles, CA (US)

(21) Appl. No.: 16/565,570

(22) Filed: Sep. 10, 2019

Related U.S. Application Data
(60) Provisional application No. 62/784,603, filed on Dec. 24, 2018.

(51) Int. Cl. C22C 21/12; B33Y 70/00; C22C 1/02

(52) U.S. Cl. CPC C22C 21/12; C22C 1/026; B33Y 70/00

(57) ABSTRACT

Some variations provide an aluminum alloy comprising aluminum and from 0.5 wt % to 60 wt % of an alloy element X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu, and combinations or alloys thereof, wherein the alloy element X is present as an intermetallic precipitate containing Al and X. An exemplary intermetallic precipitate is Al₃Zr. Some variations provide a feedstock powder comprising: from 80 wt % to 99 wt % of an aluminum-containing base powder with an average particle size from 10 microns to 500 microns; and, intimately mixed with the base powder, from 1 wt % to 20 wt % of an alloying powder with average particle size from 0.01 microns to 90 microns, containing an alloy element X or a hydride, carbide, oxide, nitride, boride, or sulfide thereof.

### PRIORITY DATA

This patent application is a non-provisional application with priority to U.S. Provisional Patent App. No. 62/784,603, filed on Dec. 24, 2018, which is hereby incorporated by reference herein.

### FIELD OF THE INVENTION

The present invention generally relates to high-temperature aluminum alloys and feedstocks for additively manufacturing high-temperature aluminum alloys.

### BACKGROUND OF THE INVENTION

Aluminum and its alloys are characterized by a relatively low density, high electrical and thermal conductivities, and a resistance to corrosion in some common environments, including the ambient atmosphere. Recent attention has been given to alloys of aluminum as engineering materials for transportation to reduce fuel consumption due to high specific strength. The low density (and therefore part weight) of aluminum is an advantage for weight-critical components.

There is a commercial desire for structures formed of aluminum alloys that exhibit high strength at temperatures up to 300° C. Such structures include, for example, aluminum-alloy structures in the propulsion and exhaust system of commercial and military aircraft that are exposed to elevated temperatures; aluminum-alloy structures of high-speed vehicles that are exposed to elevated temperatures due to aerothermal heating; and motor-vehicle powertrain aluminum-alloy parts that are exposed to elevated temperatures, such as pistons, connecting rods, cylinder heads, and brake calipers.

The mechanical strength of aluminum may be enhanced by cold work and by alloying. Common alloying elements include copper, magnesium, silicon, zinc, and manganese. Generally, aluminum alloys are classified as either cast or wrought. Some common cast, heat-treatable aluminum alloys include Al 295.0 and Al 356.0 (the decimal point denotes a cast alloy). Wrought alloys include heat-treatable alloys (e.g., Al 2104, Al 6061, and Al 7075) and non-heat-treatable alloys (e.g., Al 1100, Al 3003, and Al 5052). Wrought, heat-treatable aluminum alloys are generally superior in mechanical strength compared to other types of Al alloys.

Metal-based additive manufacturing, or three-dimensional (3D) printing, has applications in many industries, including the aerospace and automotive industries. Building up metal components layer by layer increases design freedom and manufacturing flexibility, thereby enabling complex geometries while eliminating traditional economy-of-scale constraints. However, limitations of printable alloys, especially with respect to specific strength, fatigue life, and fracture toughness, have hindered metal-based additive manufacturing. See Martin et al., “3D printing of high-strength aluminium alloys,” Nature vol. 549, pages 365-369.

Specifically regarding aluminum alloys, printable aluminum alloys based on the binary Al—Si system tend to converge around a yield strength of approximately 200 MPa with a low ductility of 4%. Most aluminum alloys used in automotive, aerospace, and consumer applications are wrought alloys of the 2000, 5000, 6000, or 7000 series, which can exhibit strengths exceeding 400 MPa and ductility of more than 10% but have not commercially been additively manufactured. These systems have low-cost alloying elements (Cu, Mg, Zn, and Si) to produce complex strengthening phases during subsequent aging. These same elements promote large solidification ranges, leading to hot tearing (cracking) during solidification.

There is a desire for additively manufactured aluminum alloys that have good mechanical properties at elevated temperatures, such as 300° C., for the aforementioned commercial applications and others. Feedstock powders suitable for fabricating such aluminum alloys are needed.

### SUMMARY OF THE INVENTION

The present invention addresses the aforementioned needs in the art, as will now be summarized and then further described in detail below.

Some variations of the invention provide an aluminum alloy comprising aluminum and from about 0.5 wt % to about 60 wt % of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu, and combinations or alloys of any of the foregoing, wherein the at least one of the alloy elements X is present as intermetallic precipitates containing Al and X within the aluminum alloy, and wherein wt % is based on the total weight concentration, on an elemental basis, of the alloy elements X.

In some embodiments, one or more alloy elements X is present at a total weight concentration that exceeds its equilibrium solubility in aluminum, calculated at 750° C. and 1 bar. When more than one alloy element X is present, some or all of the X elements may exceed their equilibrium solubilities in aluminum, calculated at 750° C. and 1 bar. When more than one alloy element X is present, at least one element X is present as an intermetallic precipitates containing Al and X, while other elements X may or may not be in the form of intermetallic precipitates.

The intermetallic precipitates may be AlₙXₘ (n=1 to 15, m=1 to 15) precipitates. For example, in some embodiments, the intermetallic precipitates are Al₃X (n=3 and m=1) precipitates, such as Al₃Zr, Al₃Ti, etc.

The intermetallic precipitates are preferably uniformly distributed within the aluminum alloy.

In some embodiments, the intermetallic precipitates are characterized by an average effective diameter of less than 100 microns. In various embodiments, the intermetallic precipitates are characterized by an average effective diameter of about 10 microns or less, about 1 micron or less, or about 100 nanometers or less.

In some embodiments, the aluminum alloy comprises from about 1 wt % to about 60 wt % of the one or more alloy elements X. In various embodiments, the aluminum alloy comprises from about 1 wt % to about 10 wt %, or from about 0.75 wt % to about 30 wt %, of the one or more alloy elements X.

In certain embodiments, X is Zr, and the aluminum alloy comprises from about 0.5 wt % to about 5 wt % of Zr.

The aluminum alloy may comprise at least two, at least three, or more of the alloy elements X.

The aluminum alloy further may comprise from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be, and combinations or alloys of any of the foregoing, wherein wt % is based on the total weight concentration, on an elemental basis, of the additional alloy elements.

Some embodiments provide an aluminum alloy consisting essentially of (a) aluminum; (b) from about 0.5 wt % to about 60 wt % of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu, and combinations or alloys of any of the foregoing, wherein the at least one of the alloy elements X is present as intermetallic precipitates containing Al and X within the aluminum alloy; and (c) optionally from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be, and combinations or alloys of any of the foregoing, wherein wt % is based on the total weight concentration, on an elemental basis, of the alloy elements X or the additional alloy elements. When the aluminum alloy contains such one or more additional alloy elements (besides the X elements), one or more of the additional alloy elements may be in the form of intermetallic precipitates containing Al and an additional alloy element (e.g., Al₂Cu, Al₂Ag, Al₄C₃, etc.).

In certain embodiments, the aluminum alloy contains from about 5 wt % to about 7 wt % Cu, from about 0.2 wt % to about 0.5 wt % Mn, and from about 1 wt % to about 5 wt % of the one or more alloy elements X (e.g., Zr).

The aluminum alloy may be an additively manufactured aluminum alloy. The aluminum alloy may be present in an aluminum alloy-based part, sheet, or structural object.

Some variations of the invention provide a feedstock powder for an aluminum alloy, the feedstock powder comprising:

(a) from about 80 wt % to about 99 wt % of an aluminum-containing base powder, wherein the aluminum-containing base powder has an average base particle size from about 10 microns to about 500 microns, and wherein the aluminum-containing base powder contains at least 75 wt % aluminum; and
(b) from about 1 wt % to about 20 wt % of an alloying powder, wherein the alloying powder has an average alloy particle size from about 0.01 microns to about 90 microns, wherein the alloying powder contains at least 50 wt % (based on the total weight concentration, on an elemental basis) of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu; hydrides, carbides, oxides, nitrides, borides, or sulfides thereof; and combinations or alloys of any of the foregoing,
wherein if the average alloy particle size is larger than 20 microns, then the average alloy particle size is preferably smaller than the average base particle size, and
wherein the aluminum-containing base powder and the alloying powder are in intimate physical contact within the feedstock powder.

In some embodiments, the average base particle size is from about 10 microns to about 100 microns. The aluminum-containing base powder preferably contains base particles that are nominally spherical.

In some embodiments, the average alloy particle size is from about 0.01 microns to about 25 microns. In various embodiments, the average alloy particle size is from about 0.01 microns to about 10 microns, or from about 0.01 microns to about 1 micron. It is preferred that the average alloy particle size is smaller than the average base particle size, noting that there can be overlap depending on the particle-size distributions of the base particles and the alloy particles. In some embodiments, the average base particle size is at least 5 times larger than said average alloy particle size. The alloying powder preferably contains alloying particles that are nominally spherical.

The one or more alloy elements X may be present in the feedstock powder at a total weight concentration that exceeds its equilibrium solubility in aluminum, calculated at 750° C. and 1 bar. When more than one alloy element X is present, some or all of the X elements may exceed their equilibrium solubilities in aluminum, calculated at 750° C. and 1 bar.

In some embodiments, the alloying powder is a particle mixture with at least two different compositions. In these or other embodiments, the alloying powder comprises at least two, at least three, or more of the alloy elements X.

The feedstock powder further may comprise from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be; hydrides, carbides, oxides, nitrides, borides, or sulfides thereof; and combinations or alloys of any of the foregoing, wherein wt % is based on the total weight concentration, on an elemental basis, of the additional alloy elements. These additional alloy elements may be present within the aluminum-containing base powder, or may be provided as a separate component within the overall feedstock powder.

Some embodiments provide a feedstock powder for an aluminum alloy, the feedstock powder consisting essentially of:

(a) from about 80 wt % to about 99 wt % of an aluminum-containing base powder, wherein the aluminum-containing base powder has an average base particle size from about 10 microns to about 500 microns, and wherein the aluminum-containing base powder contains at least 75 wt % aluminum and optionally from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be; hydrides, carbides, oxides, nitrides, borides, or sulfides thereof; and combinations or alloys of any of the foregoing, wherein wt % is based on the total weight concentration, on an elemental basis, of the additional alloy elements; and
(b) from about 1 wt % to about 20 wt % of an alloying powder, wherein the alloying powder has an average alloy particle size from about 0.01 microns to about 90 microns, wherein the alloying powder contains at least 50 wt % (based on the total weight concentration, on an elemental basis) of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu; hydrides, carbides, oxides, nitrides, borides, or sulfides thereof; and combinations or alloys of any of the foregoing,
wherein the average alloy particle size is preferably smaller than the average base particle size, and
wherein the aluminum-containing base powder, the alloying powder, and the additional alloy elements (if any) are in intimate physical contact within the feedstock powder.

In certain embodiments, the aluminum-containing base powder is a 2000 series aluminum alloy. In other embodiments, the aluminum-containing base powder is substantially pure aluminum.

In some embodiments, the feedstock powder comprises, or consists essentially of, from about 95 wt % to about 99 wt % of the aluminum-containing base powder and from about 1 wt % to about 10 wt % of the alloying powder, wherein the aluminum-containing base powder contains from about 90 wt % to about 94.8 wt % aluminum, from about 5 wt % to about 7 wt % Cu, and from about 0.2 wt % to about 0.5 wt % Mn. In these embodiments, X may be Zr, ZrH₂, or a combination thereof, for example.

In some embodiments, the alloying powder is chemically bonded to the aluminum-containing base powder. Alternatively, or additionally, the alloying powder may be physically bonded to the aluminum-containing base powder.

### BRIEF DESCRIPTION OF THE FIGURES

FIG. 1 is a notional equilibrium phase diagram of aluminum (Al) and an alloy element X, wherein X is Zr, Ti, Hf, V, Ta, Nb, Cr, Mo, W, Sc, Y, La, Ce, Pr, Nd, Sm, Eu, Gd, Tb, Dy, Ho, Er, Tm, Yb, or Lu, in some embodiments.

FIG. 2 is a scanning electron microscopy image (scale bar 500 microns) of a base powder for selective laser melting, in the Example.

FIG. 3 is a photograph of 3D-printed test specimens fabricated out of the modified Al-2219 alloy with 2 wt % Zr after hot-isostatic-press treatment, in the Example.

FIG. 4 is a graph of tensile test stress-strain curves of a modified Al-2219 alloy with 2 wt % Zr, in the Example.

FIG. 5 is a table of tensile test results of 3D-printed modified Al-2219 alloy with 2 wt % Zr, compared to Al-2219-O, in the Example.

### DETAILED DESCRIPTION OF EMBODIMENTS OF THE INVENTION

The compositions, structures, and systems of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of.”

The present invention provides an aluminum alloy system with high strength at elevated temperatures. Some variations utilize a high volume fraction of AlₙXₘ precipitates, wherein X is selected from Zr, Ti, Hf, V, Ta, Nb, Cr, Mo, W, Sc, Y, the lanthanide elements, or a combination thereof, and wherein n=1 to 15 and m=1 to 15. In principle, an alloy element X may be selected from IUPAC (International Union of Pure and Applied Chemistry) Groups 3, 4, 5, 6, and/or lanthanide series of elements.

In the aluminum alloy, one or more X elements are present at concentrations above their solubility limit(s) in aluminum. Without limitation, variations of the invention enable aluminum alloys with X element fractions above equilibrium solubility limits by adding small particles containing the X elements to a powder of the remaining constituents of the target alloy, and then additively manufacturing the parts.

Preferably, the X elements are initially provided in 0.01-20 micron powder form, blended with 10-500 micron powder of the other desired constituents of the aluminum alloy feedstock. The aluminum alloy feedstock is subsequently processed by additive manufacturing to fabricate a desired part, or potentially to make an aluminum alloy object that itself may be a feedstock for a future process.

While the remainder of the specification will describe variations of the invention specific to additive manufacturing, it will be understood that the principles disclosed herein may be applied to joining techniques, such as welding, or other metal processing that melts and solidifies at least a portion of a starting powder.

The additively manufactured aluminum alloy contains intermetallic precipitates of Al and X (e.g., Al₃X precipitates), preferably uniformly dispersed throughout the additively manufactured aluminum alloy. Uniform distributions of AlₙXₘ precipitates at high volume fractions have not been possible to achieve with conventional processing. The present invention overcomes this prior limitation. Heretofore, AlₙXₘ precipitates were not generated at a large weight fraction, because the solubility of X in Al is relatively low (for example, on the order of 0.1 wt % for Zr in Al). This limitation is overcome by adding small particles containing the X element(s) to a powder of the remaining constituents of the target alloy, and then additively manufacturing the parts.

The uniform dispersion of intermetallic precipitates containing Al and X, such as (but not limited to) Al₃X precipitates, strengthens the aluminum alloy at room temperature as well as at elevated temperatures, such as 300° C. Without being limited by theory, it is believed that strengthening is achieved by dispersion of intermetallic precipitates containing Al and X, among other strengthening mechanisms that may occur. Al₃X precipitates, for example, are stable at temperatures above the melting point of aluminum and therefore are capable of providing strength at elevated temperatures—in contrast to other precipitates such as MgZn₂ or Guinier-Preston zones, which dissolve at elevated temperatures in aluminum alloys.

Some variations of the invention provide an aluminum alloy comprising aluminum and from about 0.5 wt % to about 60 wt % of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu, and combinations or alloys of any of the foregoing, wherein the at least one of the alloy elements X is present as intermetallic precipitates containing Al and X within the aluminum alloy, and wherein wt % is based on the total weight concentration, on an elemental basis, of the alloy elements X (i.e., in a compound containing X, only the weight of elemental X is counted).

The intermetallic precipitates may be AlₙXₘ (n=1 to 15, m=1 to 15) precipitates. The value of n may be 1, 2, 3, 4, 5, 6, 7, 8, 9, 10, 11, 12, 13, 14, and/or 15. Independently, the value of m may be 1, 2, 3, 4, 5, 6, 7, 8, 9, 10, 11, 12, 13, 14, and/or 15. For example, in some embodiments, the intermetallic precipitates are Al₃X precipitates (e.g., Al₃Zr, Al₃Ti, etc.).

The melting points of Zr, Ti, Hf, V, Ta, Nb, Cr, Mo, W, Sc, Y, La, Ce, Pr, Nd, Sm, Eu, Gd, Tb, Dy, Ho, Er, Tm, Yb, and Lu all exceed the melting point of Al, which is about 660° C. It is preferred that the alloy elements, and intermetallic precipitates formed from them, have a higher melting point than aluminum because the intention is that during additive manufacturing, the X elements do not melt but rather form intermetallic inclusions, which themselves have a higher melting point than aluminum and thus also do not melt.

In some embodiments, one or more alloy elements X is present at a total weight concentration that exceeds its equilibrium solubility in aluminum, calculated at 750° C. and 1 bar. When more than one alloy element X is present, some or all of the X elements may exceed their equilibrium solubilities in aluminum, calculated at 750° C. and 1 bar. When more than one alloy element X is present, at least one element X is present as an intermetallic precipitates containing Al and X, while other elements X may or may not be in the form of intermetallic precipitates.

Equilibrium solubilities of X elements in aluminum are known. For example, see Smithells Metals Reference Book, Eds. Gale and Totemeier, Eighth Edition, 2004 (hereinafter, “Smithells”) which is hereby incorporated by reference (along with all internal citations) herein for all purposes. In particular, chapter 11 of Smithells includes many binary equilibrium phase diagrams that are applicable to the present disclosure.

For example, the equilibrium phase diagram of the Al—Zr system at page 11-58 of Smithells indicates the following intermetallic precipitates, in order of increasing zirconium content: Al₃Zr, Al₂Zr, Al₃Zr₂, AlZr, Al₃Zr₅, Al₂Zr₃, Al₃Zr₄, Al₄Zr₅, AlZr₂, and AlZr₃. Thus in embodiments for which X=Zr, any of these intermetallic precipitates may form or be present as inclusions in the aluminum alloy, even if not predicted to be present at thermodynamic equilibrium (i.e., for kinetic reasons).

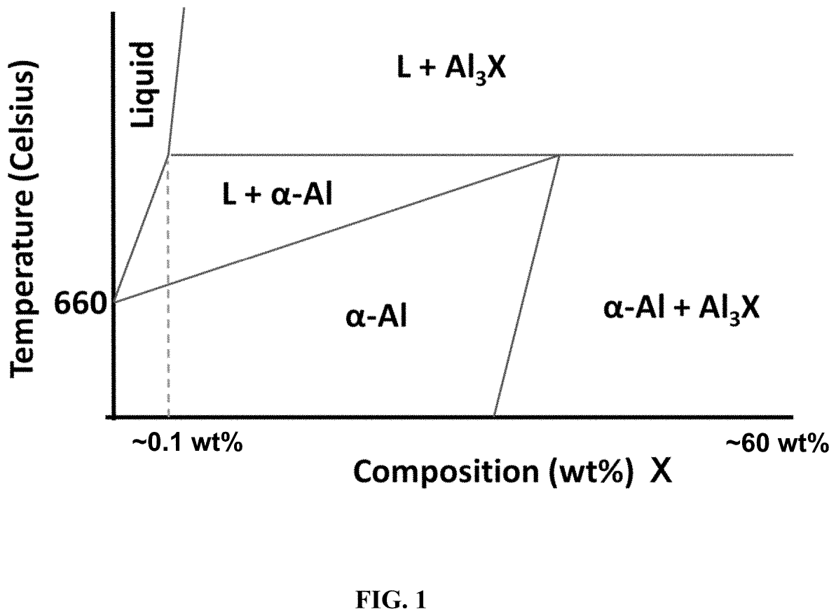

Note that at very high X concentrations (typically greater than 60 wt %), a stable X solid phase may form (not shown on FIG. 1). For example, in the case of zirconium (X=Zr) in aluminum, the phase diagram indicates that at about 90 wt % Zr (10 wt % Al), a stable β-Zr phase forms. Because the present invention utilizes an aluminum alloy with preferably 0.5-60 wt % X elements, the alloy would not be expected to contain a thermodynamically stable β-Zr phase at equilibrium. However, in embodiments for which X=Zr, zirconium (free of aluminum) metallic inclusions may form even if not predicted to be present at thermodynamic equilibrium (i.e., for kinetic reasons).

As another example, the equilibrium phase diagram of the Al—La system at page 11-41 of Smithells indicates the following intermetallic precipitates, in order of increasing lanthanum content: Al₁₁La₃, Al₃La, and Al₂La, AlLa, and AlLa₃. This example shows that Al₃X is not always the first intermetallic precipitate to form in an equilibrium phase transition that involves reaction of Al with X at low levels; in the case of La, Al₁₁La₃ may form before Al₃La forms.

FIG. 1 is a notional phase diagram of aluminum (Al) and an alloy element X. In the phase diagram of FIG. 1, X may represent any one of Zr, Ti, Hf, V, Ta, Nb, Cr, Mo, W, Sc, Y, La, Ce, Pr, Nd, Sm, Eu, Gd, Tb, Dy, Ho, Er, Tm, Yb, or Lu. In the phase diagram of FIG. 1, “L” represents a liquid phase, and a-Al represents a solid phase of pure aluminum that can have small amounts of X in solid solution. Al₃X represents intermetallic precipitates of Al and X, having the specific stoichiometry of Al₃X for non-limiting purposes of illustration (since Al₃X is a typical precipitate that forms when X is at low levels). The region “L+α-Al” is a mixture of liquid and solid aluminum, the region “L+Al₃X” is a mixture of liquid and solid Al₃X particles, and the region “α-Al+Al₃X” is a mixture of aluminum and Al₃X particles in solid solution. The region “Liquid” is a single solution in which X is fully dissolved. The melting point of α-Al is 660° C. The melting point of X, for all alloy elements X herein, is significantly higher than 660° C. As one example, the melting point of Zr is 1855° C.

It can be seen in FIG. 1 that liquid aluminum has a very limited solubility for X at typical casting temperatures (e.g., 670° C. to 800° C.). For example, the solubility of the elements Zr, Ta, V, Nb, Hf, and Ti in liquid Al at about 670° C. is only about 0.1 wt %, according to Smithells.

At X concentrations above about 0.1 wt %, but less than about 60 wt %, and at temperatures for which aluminum is melted, there is not a single liquid phase at equilibrium but rather a liquid phase and an Al₃X phase. That is, when more of an X element is present than its solubility limit, Al₃X will form in the liquid, at equilibrium according to FIG. 1. Unless the temperature is so high that Al₃X itself melts, Al₃X will be in the form of solid precipitates. The melting point of Al₃Zr, for example, is 1580° C., which is much higher than typical processing temperatures of less than 1000° C., e.g. 670-800° C. Solid precipitates are desirable unless the concentration of Al₃X becomes too high such that the Al₃X precipitates agglomerate in the liquid aluminum. Agglomeration of Al₃X precipitates creates large chunks with diameters larger than 100 microns, which is referred to as coarsening of the precipitates.

Generally speaking, only small Al₃X precipitates (100 microns or less) are desirable in aluminum alloys in order to increase the strength. Large precipitates (greater than 100 microns) are usually detrimental—at least for purposes of strength, since such large precipitates are often brittle. In certain cases, such as when strength is not a critical factor, the intermetallic precipitates (or a portion of them) may be larger than 100 microns, such as about 150, 200, 250, 300, 400, or 500 microns.

The phase diagram in FIG. 1 also shows that Al₃X precipitates are stable at temperatures above the melting point of aluminum (phase region “L+Al₃X”) and therefore are capable of providing strength at elevated temperatures. To strengthen the aluminum alloy while maintaining ductility, a uniform distribution of small Al₃X precipitates is desired. Preferably, the Al₃X precipitates are less than 100 μm in average size, and more preferably less than 10 μm in average size. In general, more Al₃X precipitates (generally, AlₙXₘ precipitates) will lead to higher strength until a threshold is reached at which coarsening occurs rather than stabilization of independent precipitates. The threshold concentration of AlₙXₘ (e.g., Al₃X) concentration will depend on the identity of alloy element (s) X, the diffusivity of the precipitate species within the aluminum-rich matrix, and the temperature and temperature history of the process.

In some embodiments, one or more X elements are present at concentrations high above their equilibrium solubility limit in aluminum, such as 2×, 3×, 5×, 10×, 25×, 50×, or 100× of the equilibrium solubility calculated at a temperature of 750° C. and a pressure of 1 bar, for example. As an illustration, if the equilibrium solubility limit of X is about 0.2 wt % in aluminum at 750° C. and 1 bar, then the aluminum alloy may comprise about 0.4 wt %, about 0.6 wt %, about 1 wt %, about 2 wt %, about 5 wt %, about 10 wt %, or about 20 wt %, respectively, of the alloy element X on an elemental weight basis.

When more than one X element is present, the equilibrium phase diagrams become more complex due to thermodynamic interactions between each X element with Al, and between all X elements. On page 11-533, Smithells states that “the literature is very large” and provides a list of references. One skilled in the materials-science art will understand that aluminum alloy multicomponent phase diagrams may be found in the literature, or if not readily available, may be generated via experimentation.

As suggested above, non-equilibrium phases may be present due to kinetic limitations (e.g., reaction kinetics and/or mass-transfer rates) that prevent equilibrium among all materials present. The present invention is not limited to any systems being at thermodynamic equilibrium and does not preclude non-equilibrium phases being present in any of the aluminum alloys or precursors thereof. In some cases, a non-equilibrium composition is desired. As is known, whether a metal alloy system will reach true thermodynamic equilibrium is dictated by kinetic constraints including temperature, time, and the presence of catalysts or nucleation sites. Even when a new phase is predicted in a phase diagram, atomic rearrangements via diffusion are necessary, and there is an increase in energy associated with the phase boundaries that are created between parent and product phases, which energy must be overcome, such as via heat transfer. In some embodiments, additive manufacturing is carried out using an effective temperature profile and time such that the aluminum alloy fabricated has a composition predicted by equilibrium.

The intermetallic precipitates are preferably uniformly distributed within the aluminum alloy. Uniform distribution of intermetallic precipitates means that they are randomly dispersed throughout the aluminum alloy, and the local concentration of intermetallic precipitates within any selected region of aluminum alloy is statistically the same as any other arbitrary region of aluminum alloy.

In some embodiments, the intermetallic precipitates are characterized by an average effective diameter of less than 100 microns. In various embodiments, the intermetallic precipitates are characterized by an average effective diameter of about 10 microns or less, about 1 micron or less, or about 100 nanometers or less. In some embodiments, the intermetallic precipitates are characterized by an average effective diameter of about, or at least about, 0.01 microns, 0.1 microns, 0.5 microns, 1 micron, 5 microns, 10 microns, 20 microns, 50 microns, or 75 microns. In various embodiments, the intermetallic precipitates are characterized by an average effective diameter from about 0.1 microns to about 100 microns, or about 0.1 microns to about 50 microns, or about 0.1 microns to about 20 microns, or about 0.1 microns to about 10 microns, or about 1 micron to about 100 microns, or about 1 micron to about 50 microns, or about 1 micron to about 20 microns, or about 1 micron to about 10 microns. The intermetallic precipitates may also be very small, such as from about 0.001 microns (1 nanometer) to about 0.1 microns (100 nanometers).

In some embodiments, the aluminum alloy comprises from about 1 wt % to about 60 wt % of the one or more alloy elements X. In various embodiments, the aluminum alloy comprises from about 1 wt % to about 10 wt %, or from about 0.75 wt % to about 30 wt %, of the one or more alloy elements X. In various embodiments, the aluminum alloy comprises about, or at least about, 0.2, 0.3, 0.4, 0.5, 0.55, 0.6, 0.7, 0.8, 0.9, 1, 2, 3, 4, 5, 10, 15, 20, 25, 30, 35, 40, 45, 50, or 55 wt % of the one or more alloy elements X. The desired concentration of an alloy element X may be dictated by its density; less weight of a high-density X element may be used, for example, to reach a similar volumetric effect.

In preferred embodiments, the aluminum alloy contains an alloy element X in a concentration that is below the stoichiometric threshold to form a uniform stable intermetallic compound, such as Al₃X. In the case of X=Zr, for example, the stoichiometric threshold to form the uniform stable intermetallic compound Al₃Zr is 47 wt % aluminum and thus 53 wt % Zr (based on the atomic masses of Al and Zr, and the 3:1 stoichiometry between Al and Zr in Al₃Zr). Therefore, in the case of zirconium, it is preferred that the Zr concentration is less than 53 wt % in the aluminum alloy. More preferably, the aluminum alloy contains an alloy element X in a concentration that is below one-half the stoichiometric threshold to form a uniform stable intermetallic compound, such as Al₃X. Again, in the case of Zr, it is more preferred that the Zr concentration is less than 27 wt % in the aluminum alloy. In various embodiments, the aluminum alloy contains an alloy element X in a concentration that is below 100%, 90%, 80%, 70%, 60%, 50%, 40%, 30%, 20%, or 10% of the stoichiometric threshold to form a uniform stable intermetallic compound. For instance, 10% of the stoichiometric threshold to form Al₃Zr is about 5.3 wt % zirconium in the aluminum alloy.

In certain embodiments, X is Zr, and the aluminum alloy comprises from about 0.5 wt % to about 5 wt % of Zr.

The aluminum alloy may comprise at least two, at least three, at least four, at least five, or more of the alloy elements X.

The aluminum alloy further may comprise from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be, and combinations or alloys of any of the foregoing, wherein wt % is based on the total weight concentration, on an elemental basis, of the additional alloy elements. In various embodiments, the aluminum alloy comprises about, or at least about, 0.2, 0.5, 1, 2, 3, 4, 5, 6, 7, 8, 9, 10, 11, 12, 13, or 14 wt % of such one or more additional alloy elements.

The one or more additional alloy elements, when present, may be added for a wide variety of reasons. For example, elements such as Mn may provide solid solution strengthening, Mg and Zn may form MgZn₂ precipitates, Cu may form θ-phase precipitates, and Si may form immiscible Si structures. Typical precipitation additions (e.g., Mg, Zn, and/or Cu), as well as other less common precipitate systems and alloy additions (e.g., Fe, Co, Ni, Ag, Li, Sn, Sb, Bi, Pb, B, C, Ir, Os, Re, Ca, Sr, and/or Be) may be added to the alloy to form not only strengthening precipitates, but also to dissolve at the desired operating temperature in order to provide solid solution strengthening. Additionally, these elements may segregate to precipitate boundaries, thereby decreasing the activity of these boundaries and providing an energy barrier that inhibits coarsening, giving improved properties at elevated temperatures for longer durations without microstructural degradation.

Some embodiments provide an aluminum alloy consisting essentially of (a) aluminum; (b) from about 0.5 wt % to about 60 wt % of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu, and combinations or alloys of any of the foregoing, wherein the at least one of the alloy elements X is present as intermetallic precipitates containing Al and X within the aluminum alloy; and (c) optionally from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be, and combinations or alloys of any of the foregoing, wherein wt % is based on the total weight concentration, on an elemental basis, of the alloy elements X or the additional alloy elements. When the aluminum alloy contains such one or more additional alloy elements (besides the X elements), one or more of the additional alloy elements may be in the form of intermetallic precipitates containing Al and the additional alloy element (e.g., Al₂Cu, Al₂Ag, Al₄C₃, etc.).

In addition to the intermetallic precipitates containing Al and X, other precipitates containing X but not Al may be present, such as inclusions of metal X with another element besides Al. For example, X-containing precipitates may be ceramics formed from metal X, and/or X hydrides, X carbides, X oxides, X nitrides, X borides, X sulfides, or combinations thereof. An exemplary ceramic and X oxide, when X=Zr, is zirconium dioxide, ZrO₂.

Non-metal inclusions may also be present in the aluminum alloy, in addition to the intermetallic precipitates and any other metal alloy elements. Such non-metal inclusions may include ceramics, hydrides, carbides, oxides, nitrides, borides, sulfides, or combinations thereof (e.g., silicon carbide, silicon nitride, boron oxide, etc.).

In certain embodiments, the aluminum alloy contains from about 5 wt % to about 7 wt % Cu, from about 0.2 wt % to about 0.5 wt % Mn, and from about 1 wt % to about 5 wt % of the one or more alloy elements X (e.g., Zr).

The aluminum alloy may be an additively manufactured aluminum alloy. In other embodiments, the aluminum alloy may be a welded aluminum alloy. In some embodiments, the aluminum alloy forms a feedstock alloy (e.g., a feedstock ingot) intended for a future process, such as additive manufacturing.

The aluminum alloy may be present in an aluminum alloy-based part, sheet, or structural object. An aluminum alloy-based part or structural object is preferably an additively manufactured part or structural object. The aluminum alloy may be selected from the group consisting of a sintered structure, a coating, a geometric object, a billet, an ingot, a net-shape part, a near-net-shape part, and combinations thereof.

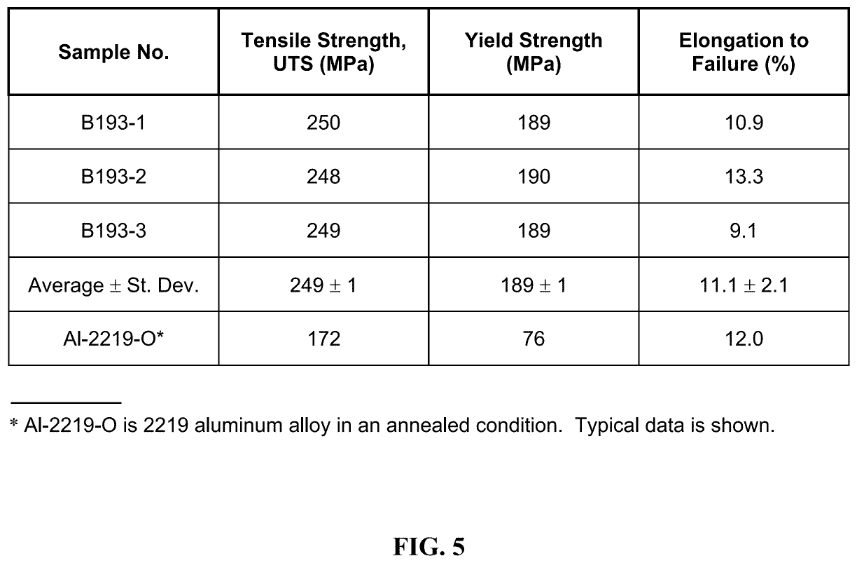

The aluminum alloy provided herein, or a part, sheet, or structural object formed from the aluminum alloy, may be characterized by a yield strength, measured at 25° C., of at least 100, 125, 150, 175, 200, or 250 MPa. An exemplary yield strength is 189 MPa as shown in FIG. 5, from experimental results according to the Example below. In some embodiments, the yield strength does not substantially decrease with temperature, from 25° C. to 300° C. The yield strength, measured at 50° C., 100° C., 200° C., or 300° C. may be at least 100, 125, 150, 175, 200, or 250 MPa, for example. A high yield strength at elevated temperatures (higher than room temperature) is believed to be a result of the intermetallic precipitates dispersed uniformly within the aluminum alloy, without being limited by theory. An aluminum alloy that has a high yield strength at elevated temperatures and/or a yield strength that does not substantially decrease with temperature, may be referred to as a “high-temperature aluminum alloy.”

The aluminum alloy provided herein, or a part, sheet, or structural object formed from the aluminum alloy, may be characterized by an ultimate tensile strength (UTS, also known as tensile strength), measured at 25° C., of at least 175, 200, 225, 250, or 300 MPa. An exemplary tensile strength is 249 MPa as shown in FIG. 5, from experimental results according to the Example below. In some embodiments, the tensile strength does not substantially decrease with temperature, from 25° C. to 300° C. The tensile strength, measured at 50° C., 100° C., 200° C., or 300° C. may be at least 175, 200, 225, 250, or 300 MPa, for example. A high tensile strength at elevated temperatures (higher than room temperature) is believed to also be a result of the intermetallic precipitates dispersed uniformly within the high-temperature aluminum alloy, without being limited by theory.

The aluminum alloy provided herein, or a part, sheet, or structural object formed from the aluminum alloy, may be characterized by an elongation to failure, measured at 25° C., of at least 5%, 6%, 7%, 8%, 9%, 10%, 11%, 12%, 13%, 14%, or 15%. An exemplary elongation to failure is 11% as shown in FIG. 5, from experimental results according to the Example below. The elongation to failure is a measure of the ductility of the alloy, which is usually a desirable property to avoid brittle fracture. In some embodiments, the ductility of a high-temperature aluminum alloy does not substantially decrease with temperature, from 25° C. to 300° C. In other embodiments, the ductility of a high-temperature aluminum alloy increases (higher elongation) with temperature from 25° C. to 300° C.

In some embodiments, the aluminum alloy has a microstructure that is “substantially crack-free” which means that at least 99.9 vol % of the aluminum alloy contains no linear or tortuous cracks that are greater than 0.1 microns in width and greater than 10 microns in length. In other words, to be considered a crack, a defect must be a void space that is at least 0.1 microns in width as well as at least 10 microns in length. A void space that has a length shorter than 10 microns but larger than 1 micron, regardless of width, can be considered a porous void (see below). A void space that has a length of at least 10 microns but a width shorter than 0.1 microns is a molecular-level gap that is not considered a defect. Typically, a crack contains open space, which may be vacuum or may contain a gas such as air, CO₂, N₂, and/or Ar. A crack may also contain solid material different from the primary material phase of the aluminum alloy.

The aluminum alloy microstructure may be substantially free of porous defects, in addition to being substantially crack-free. “Substantially free of porous defects” means at least 99 vol % of the aluminum alloy contains no porous voids having an effective diameter of at least 1 micron. Preferably, at least 80 vol %, more preferably at least 90 vol %, even more preferably at least 95 vol %, and most preferably at least 99 vol % of the aluminum alloy contains no porous voids having an effective diameter of at least 1 micron. A porous void that has an effective diameter less than 1 micron is not typically considered a defect, as it is generally difficult to detect by conventional non-destructive evaluation. Also preferably, at least 90 vol %, more preferably at least 95 vol %, even more preferably at least 99 vol %, and most preferably at least 99.9 vol % of the aluminum alloy contains no larger porous voids having an effective diameter of at least 5 microns.

Typically, a porous void contains open space, which may be vacuum or may contain a gas such as air, CO₂, N₂, and/or Ar. Porous voids may be reduced or eliminated, in some embodiments. For example, additively manufactured metal parts may be hot-isostatic-pressed to reduce residual porosity, optionally to arrive at a final additively manufactured metal part that is substantially free of porous defects in addition to being substantially crack-free.

The aluminum alloy or a part containing such alloy may have porosity from 0% to about 50%, for example, such as about 5%, 10%, 20%, 30%, 40%, or 50%, in various embodiments. The porosity may derive from space both within particles (e.g., hollow shapes) as well as space outside and between particles. The total porosity accounts for both sources of porosity.

In some embodiments, the aluminum alloy microstructure has “equiaxed grains” which means that at least 90 vol %, preferably at least 95 vol %, and more preferably at least 99 vol % of the aluminum alloy contains grains that are roughly equal in length, width, and height. In preferred embodiments, at least 99 vol % of the aluminum alloy contains grains that are characterized in that there is less than 25%, preferably less than 10%, and more preferably less than 5% standard deviation in each of average grain length, average grain width, and average grain height. In the aluminum alloy, crystals of metal alloy form grains in the solid. Each grain is a distinct crystal with its own orientation. The areas between grains are known as grain boundaries. Within each grain, the individual atoms form a crystalline lattice. In this disclosure, equiaxed grains result when there are many nucleation sites arising from the intermetallic precipitates (e.g., Al₃X) contained in the aluminum alloy microstructure.

In some embodiments, an additively manufactured aluminum alloy microstructure has a crystallographic texture that is not solely oriented in an additive-manufacturing build direction. For example, the additively manufactured aluminum alloy microstructure may contain a plurality of dendrite layers having differing primary growth-direction angles with respect to each other.

Some variations of the invention provide a feedstock powder for an aluminum alloy, the feedstock powder comprising:

(a) from about 80 wt % to about 99 wt % of an aluminum-containing base powder, wherein the aluminum-containing base powder has an average base particle size from about 10 microns to about 500 microns, and wherein the aluminum-containing base powder contains at least 75 wt % (e.g., at least 80 wt % or at least 85 wt %) aluminum; and
(b) from about 1 wt % to about 20 wt % of an alloying powder, wherein the alloying powder has an average alloy particle size from about 0.01 microns to about 90 microns, wherein the alloying powder contains at least 50 wt % (based on the total weight concentration, on an elemental basis) of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu; hydrides, carbides, oxides, nitrides, borides, or sulfides thereof; and combinations or alloys of any of the foregoing,
wherein if the average alloy particle size is larger than 20 microns, then the average alloy particle size is preferably smaller than the average base particle size, and
wherein the aluminum-containing base powder and the alloying powder are in intimate physical contact within the feedstock powder.

The “base powder” contains at least aluminum present in powder particles. The base powder has a composition that is calculated to contain the constituents that will form the target alloy composition when combined with the intended fraction of alloying powder. The “alloying powder” is rich in X (as one or more elements) and typically has a smaller particle size than the base powder.

A feedstock powder may be in any form in which discrete particles can be reasonably distinguished from the bulk. The powder may be present as loose powders, a paste, a suspension, or a green body, for example. A green body is an object whose main constituent is weakly bound powder material, before it has been melted and solidified. Particles may be solid, hollow, or a combination thereof. Particles can be made by any means including, for example, gas atomization, milling, cryomilling, wire explosion, laser ablation, electrical-discharge machining, or other techniques known in the art.

“Intimate physical contact” between the base powder and the alloying powder means that the two powders are physically blended (mixed) together, to form the feedstock powder. In some embodiments, there are chemical bonds between alloy particles and base powder particles. Chemical bonding results in intimate physical contact between the alloying powder and the aluminum-containing base powder.

Some embodiments of the present invention utilize materials, methods, and principles described in commonly owned U.S. patent application Ser. No. 15/209,903, filed Jul. 14, 2016, and/or commonly owned U.S. patent application Ser. No. 15/808,877, filed Nov. 9, 2017, each of which is hereby incorporated by reference herein. For example, certain embodiments utilize functionalized powder feedstocks as described in U.S. patent application Ser. No. 15/209,903. The present disclosure is not limited to those functionalized powders. This specification also hereby incorporates by reference herein Martin et al., “3D printing of high-strength aluminium alloys,” Nature vol. 549, pages 365-369 and supplemental online content (extended data), Sep. 21, 2017, in its entirety.

In some embodiments, alloying powder particles coat base powders in the form of a continuous coating or an intermittent coating, either of which may be referred to as a surface-functionalized base powder. A continuous coating covers at least 90% of the surface, such as about 95%, 99%, or 100% of the surface (recognizing there may be defects, voids, or impurities at the surface). An intermittent coating is non-continuous and covers less than 90%, such as about 80%, 70%, 60%, 50%, 40%, 30%, 20%, 10%, 5%, 2%, 1%, or less of the surface. An intermittent coating may be uniform (e.g., having a certain repeating pattern on the surface) or non-uniform (e.g., random). In general, the coating may be continuous or discontinuous.

Methods of producing surface-functionalized powder materials are generally not limited and may include immersion deposition, electroless deposition, vapor coating, solution/suspension coating of particles with or without organic ligands, utilizing electrostatic forces and/or Van der Waals forces to attach particles through mixing, and so on. U.S. patent application Ser. No. 14/720,757 (filed May 23, 2015), U.S. patent application Ser. No. 14/720,756 (filed May 23, 2015), and U.S. patent application Ser. No. 14/860,332 (filed Sep. 21, 2015), each commonly owned with the assignee of this patent application, are hereby incorporated by reference herein.

In some embodiments, an aluminum-containing base powder is functionalized with assembled alloy powder particles that are lattice-matched to a primary or secondary solidifying phase in the parent material, or that may react with elements in the base powder to form a lattice-matched phase to a primary or secondary solidifying phase in the parent material. For example, the intermetallic precipitates (e.g., Al₃X) may be lattice-matched to an aluminum-rich phase. In some embodiments, at least one intermetallic precipitate is lattice-matched to within ±5%, preferably to within ±2%, and more preferably to within ±0.5%.

In some embodiments, the feedstock powder is provided such that the aluminum-containing base powder and the alloying powder initially are physically separated, such as in different containers, for storage or transport. At the time and place of use as a feedstock for making an aluminum alloy (e.g., at a site of additive manufacturing), the individual powders may then be blended together so that the aluminum-containing base powder and the alloying powder are in intimate physical contact with each other. The alloying powder and base powder are mixed or blended at respective amounts in order to result in the target aluminum alloy composition. This is the typical, preferred embodiment that enables the generation of intermetallic precipitates uniformly dispersed throughout the additively manufactured aluminum alloy. However, in certain situations in which a non-uniform dispersion is desired, it may be beneficial for the feedstock powder to contain regions of lower or higher concentrations of alloying powder, such as to produce a gradient of alloy composition in the final component.

In some embodiments, the average base particle size is from about 10 microns to about 100 microns. In various embodiments, the average base particle size is from about 10 microns to about 200 microns, from about 5 microns to about 100 microns, or from about 5 microns to about 50 microns. In various embodiments, the average base particle size is about, or at least about, 1 micron, 5 microns, 10 microns, 20 microns, 50 microns, 100 microns, 200 microns, 300 microns, or 400 microns.

The base powder (base particles) may have a narrow or wide particle-size distribution, although a narrow size distribution is usually preferred. The particle-size distribution may be characterized by a particle-size dispersity index, which is the ratio of particle-size standard deviation to average particle size (also known as the coefficient of variance). In various embodiments, the base powder particle-size dispersity index is about 0.05, 0.1, 0.2, 0.3, 0.4, 0.5, 0.6, 0.7, 0.8, 0.9, or 1.0.

The particle-size distribution of the base powder may also be characterized by reference to D10, D50, and D90, for example. D10 is the diameter where ten percent of the distribution has a smaller particle size and ninety percent has a larger particle size. D50 is the diameter where fifty percent of the distribution has a smaller particle size and fifty percent has a larger particle size. D90 is the diameter where ninety percent of the distribution has a smaller particle size and ten percent has a larger particle size. An exemplary base powder for additive manufacturing via selective laser melting has D10=20 microns and D90=60 microns. In various embodiments, D10 is about 1, 5, 10, 20, 30, 40, or 50 microns while D90 is about 5, 10, 20, 30, 40, 50, 60, 70, 80, 90, or 100 microns.

The aluminum-containing base powder preferably contains base particles that are nominally spherical. By “nominally spherical” it is meant that the base particles, on average, have a sphericity of at least 0.9, preferably at least 0.95, and more preferably at least 0.99. Sphericity is the measure of how closely the shape of an object approaches that of a perfect sphere. The sphericity of a particle is the ratio of the surface area of a reference sphere, having the same volume as the given particle, to the surface area of the particle. The sphericity of an ideal sphere is exactly 1. As a negative example, the sphericity of a perfect cube is about 0.8, which means a cubic particle is not nominally spherical as defined herein.

In some embodiments, the average alloy particle size is from about 0.01 microns to about 50 microns. In various embodiments, the average alloy particle size is from about 0.01 microns to about 20 microns, from about 0.01 microns to about 10 microns, or from about 0.01 microns to about 1 micron. In various embodiments, the average alloy particle size is about 10 microns or less, about 1 micron or less, about 100 nanometers or less, about 50 nanometers or less, or about 25 nanometers or less. In some embodiments, the average alloy particle size is about, or at least about, 0.01 microns, 0.1 microns, 0.5 microns, 1 micron, 5 microns, 10 microns, or 20 microns. In various embodiments, the average alloy particle size is from about 0.01 microns to about 50 microns, or about 0.01 microns to about 20 microns, or about 0.01 microns to about 10 microns, or about 0.1 microns to about 50 microns, or about 0.1 microns to about 20 microns, or about 0.1 microns to about 10 microns, or about 0.1 microns to about 1 micron.

It is preferred that the average alloy particle size is smaller than the average base particle size, noting that there can be overlap depending on the particle-size distributions of the base particles and the alloy particles. In some embodiments, the average base particle size is at least 2, at least 3, at least 4, at least 5, at least 6, at least 7, at least 8, at least 9, or at least 10 times larger than said average alloy particle size.

The alloying powder may have a narrow or wide particle-size distribution, although a narrow size distribution is preferred. In various embodiments, the alloy powder particle-size dispersity index is about 0.01, 0.02, 0.05, 0.1, 0.2, 0.3, 0.4, or 0.5.

The particle-size distribution of the alloying powder may also be characterized by reference to D10, D50, and D90, for example. In various embodiments, D10 for the alloying powder is about 0.01, 0.05, 0.1, 0.2, 0.5, 1, 2, 3, 4, 5, 10, 15, or 20 microns while D90 for the alloying powder is about 0.02, 0.05, 0.1, 0.2, 0.5, 1, 2, 3, 4, 5, 10, 20, 30, 40, 50, 60, 70, or 80 microns.

Particles sizes may be measured by a variety of techniques, including dynamic light scattering, laser diffraction, image analysis, or sieve separation, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images. Finally, sieving is a conventional technique of separating particles by size.

The alloying powder preferably contains alloying particles that are nominally spherical. The same definition as for the particles of the base powder applies, i.e., “nominally spherical” alloy particles have an average sphericity of at least 0.9, preferably at least 0.95, and more preferably at least 0.99, wherein the sphericity is the ratio of the surface area of a reference sphere, having the same volume as the given alloy particle, to the surface area of the alloy particle.

The one or more alloy elements X may be present in the feedstock powder at a total weight concentration that exceeds its equilibrium solubility in aluminum, calculated at 750° C. and 1 bar. When more than one alloy element X is present, some or all of the X elements may exceed their equilibrium solubilities in aluminum, calculated at 750° C. and 1 bar. Equilibrium solubilities of X elements in aluminum are known, such as by reference to Smithells.

In some embodiments, the alloying powder is a particle mixture with at least two different compositions. In these or other embodiments, the alloying powder comprises at least two, at least three, at least four, at least five, or more of the alloy elements X. The alloying powder may itself be an alloy of X and one or more other elements.

Hydrides, carbides, oxides, nitrides, borides, or sulfides of an alloy element X may be desirable, compared to the pure form of X, for various reasons including stability, cost, or other factors. For example, in certain embodiments, hydrogen-stabilized zirconium particles (ZrH₂) are preferred over pure Zr particles due to ZrH₂ stability in air and ability to decompose at the melting temperature, resulting in formation of a favorable Al₃Zr nucleant phase (intermetallic precipitate). The hydrogen evolves from the system and does not interfere with the alloying chemistry. In certain embodiments, hydrogen, carbon, oxygen, nitrogen, boron, or sulfur are incorporated into the final aluminum alloy. Carbon and boron, in particular, may be additional alloy elements.

The feedstock powder further may comprise from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be; hydrides, carbides, oxides, nitrides, borides, or sulfides thereof; and combinations or alloys of any of the foregoing, wherein wt % is based on the total weight concentration, on an elemental basis, of the additional alloy elements. These additional alloy elements may be present within the aluminum-containing base powder, or may be provided as a separate component within the overall feedstock powder.

It is known that some light elements, such as Zn and Mg, evaporate more rapidly during additive manufacturing and therefore the feedstock powder composition may be adjusted to contain an excess of these light element(s) so that the correct final composition, for the intended aluminum alloy, is achieved after additive manufacturing. This specification hereby incorporates by reference commonly owned U.S. patent application Ser. No. 15/996,438, filed on Jun. 2, 2018, which teaches how to enrich feedstock powders for additive manufacturing with certain light elements in order to achieve a desired final concentration of the additively manufactured component.

Some embodiments provide a feedstock powder for an aluminum alloy, the feedstock powder consisting essentially of:

(a) from about 80 wt % to about 99 wt % of an aluminum-containing base powder, wherein the aluminum-containing base powder has an average base particle size from about 10 microns to about 500 microns, and wherein the aluminum-containing base powder contains at least 75 wt % aluminum and optionally from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be; hydrides, carbides, oxides, nitrides, borides, or sulfides thereof; and combinations or alloys of any of the foregoing, wherein wt % is based on the total weight concentration, on an elemental basis, of the additional alloy elements; and
(b) from about 1 wt % to about 20 wt % of an alloying powder, wherein the alloying powder has an average alloy particle size from about 0.01 microns to about 90 microns, wherein the alloying powder contains at least 50 wt % (based on the total weight concentration, on an elemental basis) of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu; hydrides, carbides, oxides, nitrides, borides, or sulfides thereof; and combinations or alloys of any of the foregoing,
wherein the average alloy particle size is preferably smaller than the average base particle size, and
wherein the aluminum-containing base powder, the alloying powder, and the additional alloy elements (if any) are in intimate physical contact within the feedstock powder.

In certain embodiments, the aluminum-containing base powder is a 2000 series aluminum alloy. In certain embodiments, the aluminum-containing base powder contains from about 2 wt % to about 6 wt % Cu, from 0 to about 0.6 wt % Mn, and from 0 to about 0.8 wt % Si. The final aluminum alloy (following additive manufacturing) may be considered a modified 2000-series aluminum alloy, such as a modified 2219 aluminum alloy (see Example below).

The aluminum-containing base powder may be selected from the 1000 series, 2000 series, 3000 series, 4000 series, 5000 series, 6000 series, 7000 series, 8000 series, or a combination thereof.

The aluminum-containing base powder may be selected from the 2000 series of aluminum alloys. The 2000 series of aluminum alloys includes aluminum alloys 2011, 2014, 2024, 2036, 2048, 2055, 2090, 2091, 2099, 2124, 2195, 2218, 2219, 2319, and 2618. In certain embodiments, the aluminum alloy is selected from aluminum alloy 2024, aluminum alloy 2219, or a combination thereof.

The aluminum-containing base powder may be selected from the 6000 series of aluminum alloys. The 6000 series of aluminum alloys includes aluminum alloys 6005, 6009, 6010, 6060, 6061, 6063, 6063A, 6065, 6066, 6070, 6081, 6082, 6101,6105, 6151, 6162, 6201, 6205, 6262, 6351, 6463, and 6951. In certain embodiments, the aluminum alloy is selected from aluminum alloy 6061, aluminum alloy 6063, or a combination thereof.

The aluminum-containing base powder may be selected from the 7000 series of aluminum alloys. The 7000 series of aluminum alloys includes aluminum alloys 7005, 7034, 7039, 7049, 7050, 7068, 7072, 7075, 7175, 7079, 7116, 7129, 7178, and 7475. In certain embodiments, the aluminum alloy is selected from aluminum alloy 7050, aluminum alloy 7075, or a combination thereof.

In other embodiments, the aluminum-containing base powder is substantially pure aluminum (e.g., at least 99 wt %, 99.5 wt %, or 99.9 wt % Al).

In some embodiments, the feedstock powder comprises, or consists essentially of, from about 95 wt % to about 99 wt % of the aluminum-containing base powder and from about 1 wt % to about 10 wt % of the alloying powder, wherein the aluminum-containing base powder contains from about 90 wt % to about 94.8 wt % aluminum, from about 5 wt % to about 7 wt % Cu, and from about 0.2 wt % to about 0.5 wt % Mn. In these embodiments, X may be Zr, ZrH₂, or a combination thereof, for example.

The feedstock powder may be utilized in any powder-based additive manufacturing process, including, but not limited to, selective laser melting (SLM), electron beam melting (EBM), or laser engineered net shaping (LENS). In certain embodiments, the feedstock powder is first converted into another form of feedstock, such as a wire, which may be formed itself via additive manufacturing, extrusion, wire drawing, or other metal-processing techniques. The feedstock object (e.g., wire) may then be subjected to additive manufacturing.

Additive manufacturing via selective laser melting, electron beam melting, or laser engineered net shaping can process feedstock powders into alloy parts with uniform distribution (good dispersion) of AlₙXₘ (e.g., Al₃X) precipitates to provide strength and ductility. During local heating to high temperatures, but below the melting point of X, the X element(s) are dissolved and/or suspended in the melt pool. A high energy input leads to preferred turbulent mixing of the melt pool, ensuring a uniform composition within the melt pool. Rapid cooling of the melt pool leads to uniform precipitation of AlₙXₘ (e.g., Al₃X) and mitigates agglomeration and coarsening of the precipitates. Additional heat treatments, such as aging heat treatments, may then be used to optimize the precipitate size and overall microstructure, if desired.

In some embodiments, the alloying powder itself contains intermetallic inclusions AlₙXₘ, i.e., the inclusions are made prior to the additive manufacturing process and added to the feedstock powder itself. The intermetallic inclusions AlₙXₘ may be in addition to, or in place of, alloy elements X or hydrides, carbides, oxides, nitrides, or sulfides thereof. Stated another way, aluminides of alloy elements X may be included in the alloying powder. In related embodiments, a third powder, on addition to the alloying powder, may be added to the feedstock powder wherein the third powder contains intermetallic inclusions AlₙXₘ and wherein the alloying powder contains one or more alloy elements X or hydrides, carbides, oxides, nitrides, or sulfides thereof but does not contain any intermetallic inclusions AlₙXₘ. The present invention is not limited to the methods to arrive at the claimed aluminum alloy, and it is not limited to using the disclosed feedstock powders to arrive at the claimed aluminum alloy.

The disclosed feedstock powders, and/or the disclosed aluminum alloy, may be made from, or employed in, additive manufacturing, welding, pressing, sintering, mixing, dispersing, friction stir welding, extrusion, binding (such as with a polymer binder), melting, semi-solid melting, casting, or a combination thereof. Melting may include induction melting, resistive melting, skull melting, arc melting, laser melting, electron beam melting, semi-solid melting, or other types of melting (including conventional and non-conventional melt processing techniques). Casting may include centrifugal, pour, or gravity casting, for example. Sintering may include spark discharge, capacitive-discharge, resistive, or furnace sintering, for example. Mixing may include convection, diffusion, shear mixing, or ultrasonic mixing, for example.

An additive manufacturing process may be selected from the group consisting of selective laser melting, energy-beam melting, laser engineered net shaping, and combinations thereof, for example.

Selective laser melting is an additive manufacturing technique designed to use a high power-density laser to melt and fuse metallic powders together. Selective laser melting has the ability to fully melt the metal material into a solid 3D part.

Electron-beam melting is a type of additive manufacturing for metal parts. Metal powder is welded together, layer by layer, under vacuum using an electron beam as the heat source.

Laser engineered net shaping is an additive manufacturing technique developed for fabricating metal parts directly from a computer-aided design solid model by using a metal powder injected into a molten pool created by a focused, high-powered laser beam. Laser engineered net shaping is similar to selective laser sintering, but the metal powder is applied only where material is being added to the part at that moment. Note that “net shaping” is meant to encompass “near net” fabrication as well.

In any of these additive manufacturing techniques, post-production processes such as heat treatment, light machining, surface finishing, coloring, stamping, or other finishing operations may be applied. Also, several additive manufactured parts may be joined together (e.g., sintered) chemically or physically to produce a final object.

### EXAMPLE

In this Example, a modified aluminum alloy 2219 is fabricated with improved mechanical properties.

A starting aluminum alloy 2219 powder (hereinafter “Al-2219”) has the following composition:

### Aluminum: 91.5 to 93.8 wt %

### Copper: 5.8 to 6.8 wt %

Iron: 0.3 wt % maximum
Magnesium: 0.02 wt % maximum

### Manganese: 0.2 to 0.4 wt %

Silicon: 0.2 wt % maximum

### Titanium: 0.02 to 0.10 wt %

### Vanadium: 0.05 to 0.15 wt %

Zinc: 0.1 wt % maximum

### Zirconium: 0.10 to 0.25 wt %

Residuals: 0.15 wt % maximum

An aluminum alloy derived from Al-2219 is designed to provide high strength across a temperature range from 0° C. to 300° C. While Al-2219 contains the X elements zirconium Zr (0.10-0.25 wt %), vanadium V (0.05-0.15 wt %), and titanium Ti (0.02-0.10 wt %) at only their approximate solubility limits, the desired new aluminum alloy will contain a much higher amount, 2 wt %, of zirconium (X=Zr).

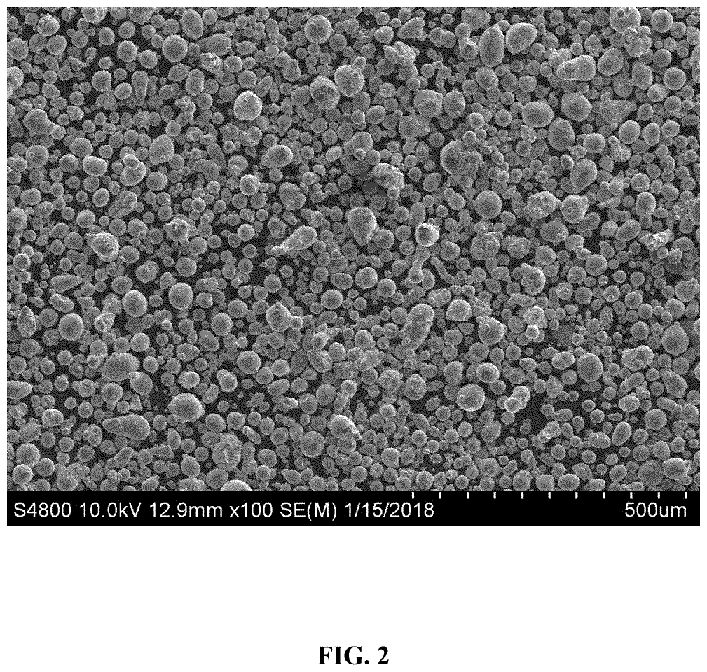

To realize the higher concentration of zirconium, a base powder is gas atomized with a composition of Al=92.6 wt %, Cu =6.7 wt %, Mn=0.35 wt %, and Ti=0.24 wt %. The base powder has a particle-size distribution suited for selective laser melting: D10=15 microns, D50=27 microns, and D90=44 microns. FIG. 2 is a scanning electron microscopy image (scale bar 500 microns) of the base powder for selective laser melting.

The zirconium powder has a much smaller particle size compared to the base powder, with an average particle size of about 0.5-1.5 microns. The zirconium powder is added to the base powder at 2 wt %. The resulting new feedstock powder is then processed into parts and test specimens by selective laser melting using a Concept Laser M2 3D printer (Concept Laser GmbH, Grapevine, Tex., USA).

Additive manufacturing is performed on the Concept Laser M2 selective laser melting machine with single-mode, CW modulated ytterbium fiber laser (1070 nm, 400 W), scan speed up to 7.9 m/s, spot size 50 μm minimum. Powder handling parameters: 80 mm×80 mm build chamber size, 70 mm×70 mm build plate size, 20-80 μm layer thickness. Layers of the build are incremented by a range from 25 μm to 80 μm depending on part geometry and location in the build. Processing is done under a flowing, inert argon atmosphere with oxygen monitoring. All processing is completed at room temperature with no applied heat. Samples are removed from the machine and cleaned of extra powder by sonicating in water. Parts are then dried with clean, compressed, dry air.

An elemental analysis of the as-printed parts results in a composition of Al=90.9 wt %, Cu=6.5 wt %, Mn=0.34 wt %, Zr=2.0 wt %, Ti=0.13 wt %, and V=0 wt %. The total concentration of X elements (Zr, Ti) is about 2.1 wt % in the fabricated aluminum alloy (modified Al-2219 alloy). Because the Zr content is significantly higher than the equilibrium solubility, most of the Zr is present in the form of Al₃Zr in the fabricated aluminum alloy. The Al₃Zr precipitates have a size range from about 1 nanometer to about 2 microns.

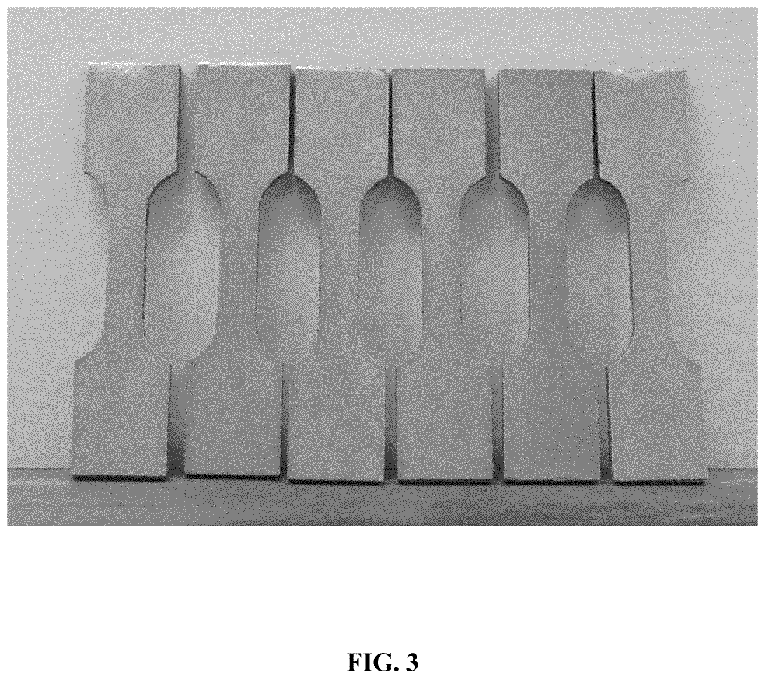

Test samples are hot-isostatic-pressed at 15 ksi and slow-cooled from 960° F. (515.6° C.). No heat treatment is applied. FIG. 3 is a photograph of 3D-printed test specimens fabricated out of the modified Al-2219 alloy with 2 wt % Zr after hot-isostatic-press treatment. The samples are allowed to sit at room temperature for 2 weeks and then tensile tested.

Tensile tests are performed on a servo-electric INSTRON 5960 frame equipped with a 50-kN load cell (INSTRON). Samples are clamped by the ends of the dog-bone-shaped samples. The extension rate is 0.2 mm/min and samples are loaded until fracture. Testing is conducted following ASTM E8.

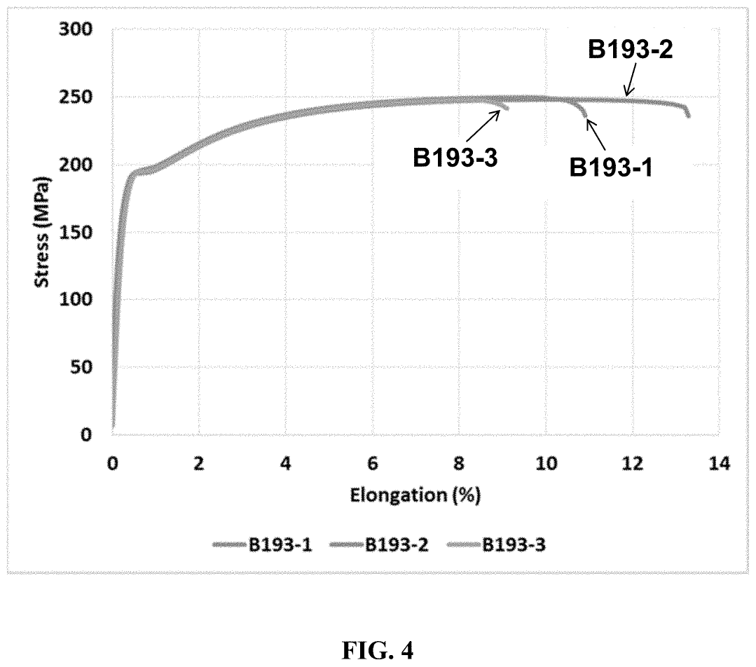

The tensile results are depicted in FIG. 4 which shows stress-strain curves of tensile tests of the modified Al-2219 alloy with 2 wt % Zr. FIG. 5 is a table of tensile test results of 3D-printed modified Al-2219 alloy with 2 wt % Zr, compared to Al-2219-O, at about 25° C. Al-2219-O is 2219 aluminum alloy in an annealed condition (typical properties for Al-2219-O are shown in the table of FIG. 5). A yield strength more than about 250% of conventional Al-2219-O is achieved, and a tensile strength of 145% of conventional Al-2219-O is achieved. The improved strength properties are believed to be due to the uniform dispersion of small Al₃Zr precipitates in the aluminum alloy. The elongation to failure (11.1%) is statistically the same as that for conventional Al-2219-O, indicating no negative impact on ductility caused by Al3Zr precipitates in the aluminum alloy.

This invention can be broadly applied to structures formed of aluminum alloys that exhibit high strength at temperatures up to 300° C. or higher. Such structures include, for example, aluminum-alloy structures in the propulsion and exhaust system of commercial and military aircraft that are exposed to elevated temperatures; aluminum-alloy structures of high-speed vehicles that are exposed to elevated temperatures due to aerothermal heating; and motor-vehicle powertrain aluminum-alloy parts that are exposed to elevated temperatures, such as pistons, connecting rods, cylinder heads, and brake calipers. Other potential applications include improved tooling, replacement of steel or titanium components at lower weight, full topological optimization of aluminum components, low-cost replacement for out-of-production components, and replacement of existing additively manufactured aluminum systems.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

What is claimed is:

1. An aluminum alloy comprising aluminum and from about 0.5 wt % to about 60 wt % of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu, and combinations or alloys of any of the foregoing, wherein said at least one of said alloy elements X is present as intermetallic precipitates containing Al and X within said aluminum alloy, and wherein wt % is based on the total weight concentration, on an elemental basis, of said alloy elements X.

2. The aluminum alloy of claim 1, wherein said one or more alloy elements X is present at a total weight concentration that exceeds equilibrium solubility in aluminum, calculated at 750° C. and 1 bar.

3. The aluminum alloy of claim 1, wherein said intermetallic precipitates are AlₙXₘ (n=1 to 15, m=1 to 15) precipitates.

4. The aluminum alloy of claim 3, wherein said intermetallic precipitates are Al₃X precipitates.

5. The aluminum alloy of claim 1, wherein said intermetallic precipitates are uniformly distributed within said aluminum alloy.

6. The aluminum alloy of claim 1, wherein said intermetallic precipitates are characterized by an average effective diameter of less than 100 microns.

7. The aluminum alloy of claim 1, wherein X is Zr, and wherein said aluminum alloy comprises from about 0.5 wt % to about 5 wt % of said Zr.

8. The aluminum alloy of claim 1, wherein said aluminum alloy further comprises from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be, and combinations or alloys of any of the foregoing, wherein wt % is based on the total weight concentration, on an elemental basis, of said additional alloy elements.

9. The aluminum alloy of claim 8, wherein said aluminum alloy contains from about 5 wt % to about 7 wt % Cu, from about 0.2 wt % to about 0.5 wt % Mn, and from about 1 wt % to about 5 wt % of said one or more alloy elements X.

10. The aluminum alloy of claim 9, wherein X is Zr.

11. The aluminum alloy of claim 1, wherein said aluminum alloy is an additively manufactured aluminum alloy.

12. The aluminum alloy of claim 1, wherein said aluminum alloy is present in an aluminum alloy-based part, sheet, or structural object.

13. A feedstock powder for an aluminum alloy, said feedstock powder comprising:
(a) from about 80 wt % to about 99 wt % of an aluminum-containing base powder, wherein said aluminum-containing base powder has an average base particle size from about 10 microns to about 500 microns, and wherein said aluminum-containing base powder contains at least 75 wt % aluminum; and
(b) from about 1 wt % to about 20 wt % of an alloying powder, wherein said alloying powder has an average alloy particle size from about 0.01 microns to about 90 microns, wherein said alloying powder contains at least 50 wt % (based on the total weight concentration, on an elemental basis) of one or more alloy elements X selected from the group consisting of Zr, Ti, Hf, V, Ta, Nb, Cr, Mo, W, Sc, Y, La, Ce, Pr, Nd, Sm, Eu, Gd, Tb, Dy, Ho, Er, Tm, Yb, Lu; hydrides, carbides, oxides, nitrides, borides, or sulfides thereof; and combinations or alloys of any of the foregoing,
wherein if said average alloy particle size is larger than 20 microns, then said average alloy particle size is smaller than said average base particle size, and
wherein said aluminum-containing base powder and said alloying powder are in intimate physical contact within said feedstock powder.

14. The feedstock powder of claim 13, wherein said aluminum-containing base powder contains base particles that are nominally spherical.

15. The feedstock powder of claim 13, wherein said average base particle size is at least 5 times larger than said average alloy particle size.

16. The feedstock powder of claim 13, wherein said alloying powder contains alloying particles that are nominally spherical.

17. The feedstock powder of claim 13, wherein said alloying powder is a particle mixture with at least two different compositions.

18. The feedstock powder of claim 13, wherein said feedstock powder further comprises from about 0.1 wt % to about 15 wt % of one or more additional alloy elements selected from the group consisting of Zn, Si, Mg, Cu, Li, Ag, Mn, Fe, Co, Ni, Sn, Sb, Bi, Pb, B, C, Ir, Os, Re, Ca, Sr, Be; hydrides, carbides, oxides, nitrides, borides, or sulfides thereof; and combinations or alloys of any of the foregoing, wherein wt % is based on the total weight concentration, on an elemental basis, of said additional alloy elements.

19. The feedstock powder of claim 13, wherein said aluminum-containing base powder is a 2000 series aluminum alloy.

20. The feedstock powder of claim 21, wherein said aluminum-containing base powder is substantially pure aluminum.

21. The feedstock powder of claim 13, wherein said feedstock powder comprises from about 95 wt % to about 99 wt % of said aluminum-containing base powder and from about 1 wt % to about 10 wt % of said alloying powder, wherein said aluminum-containing base powder contains from about 90 wt % to about 94.8 wt % aluminum, from about 5 wt % to about 7 wt % Cu, and from about 0.2 wt % to about 0.5 wt % Mn.

22. The feedstock powder of claim 21, wherein said aluminum-containing base powder consists essentially of said aluminum, from about 5 wt % to about 7 wt % Cu, and from about 0.2 wt % to about 0.5 wt % Mn.

23. The feedstock powder of claim 21, wherein X is Zr, ZrH₂, or a combination thereof.

24. The feedstock powder of claim 13, wherein said one or more alloy elements X is present in said feedstock powder at a total weight concentration that exceeds equilibrium solubility in aluminum, calculated at 750° C. and 1 bar.

25. The feedstock powder of claim 13, wherein said alloying powder is chemically and/or physically bonded to said aluminum-containing base powder.
